(19) United States
(12) Patent Application Publication
(10) Pub. No.: US 2014/0193715 A1
(43) Pub. Date: Jul. 10, 2014

(54) Lithium Secondary Battery

(71) Applicant: Samsung SDI Co., Ltd., Yongin-si (KR)

(72) Inventor: Sung-Soo Park, Yongin-si (KR)

(21) Appl. No.: 13/946,996

(22) Filed: Jul. 19, 2013

(30) Foreign Application Priority Data
Jan. 10, 2013 (KR) 10-2013-0003144

(51) Int. Cl. H01M 4/485

(52) U.S. Cl. CPC H01M 4/485
USPC 429/231.1; 429/231.5

(57) ABSTRACT

A lithium secondary battery including an anode active material including mesoporous TiO₂ doped with a heteroatom.

### CROSS-REFERENCE TO RELATED PATENT APPLICATION

This application claims priority to and the benefit of Korean Patent Application No. 10-2013-0003144, filed in the Korean Intellectual Property Office on Jan. 10, 2013, the entire disclosure of which is incorporated herein by reference.

### BACKGROUND

1. Field

The present invention relates to a lithium secondary battery.

2. Description of the Related Art

In recent years, due to increasing technological development and demand for mobile devices, there has been an increased demand for a secondary battery as an energy source. In particular, a lithium secondary battery having high-energy density and high-voltage has become commercially available and widely used.

A lithium secondary battery generally uses materials that enable intercalation or deintercalation of lithium ions as a cathode and an anode. Organic liquid electrolytes or polymer electrolytes are disposed between the cathode and the anode.

The lithium secondary battery generates electrical energy from an oxidation reaction and a reduction reaction when lithium ions are inserted and removed (intercalated and deintercalated) from the cathode and the anode.

Examples of the anode active material for the lithium secondary battery may be graphite, a high-volume silicon-based transition metal oxide, and/or a tin-based transition metal oxide.

In particular, Li₄Ti₅O₁₂ has recently being getting attention as an anode material for a lithium secondary battery. Li₄Ti₅O₁₂ generally has no structural changes despite repeated charge and discharge cycle. Also, reversible deintercalation-intercalation of lithium ions in Li₄Ti₅O₁₂ may be performed smoothly, and thus Li₄Ti₅O₁₂ is considered a useful anode active material in the development of large energy storage devices.

In addition, Li₄Ti₅O₁₂ undergoes negligible lattice expansion, and thus has excellent life-cycle characteristics. As a result of the crystal structure of Li₄Ti₅O₁₂, mobility of lithium ions is excellent, and thus characteristics of high-rate discharge in Li₄Ti₅O₁₂ are superior to other anode active materials.

However, Li₄Ti₅O₁₂ that has been developed has a capacity of only about 170 mAh/g. Therefore, Li₄Ti₅O₁₂ that has a higher capacity is desired, along with a lithium secondary battery including the same, in order to manufacture a high-capacity battery.

### SUMMARY

Aspects of embodiments of the present invention are directed to a lithium secondary battery having improved capacity.

In some embodiments, a lithium secondary battery includes a cathode including a cathode active material; an anode including an anode active material including mesoporous TiO₂ doped with a heteroatom; and an electrolyte.

The mesoporous TiO₂ doped with a heteroatom may include at least one atom selected from a Group 15 element or a Group 16 element. The heteroatom may include at least one atom selected from nitrogen (N), sulfur (S), or phosphorous (P).

The mesoporous TiO₂ doped with a heteroatom may be in an anatase phase.

An amount of the mesoporous TiO₂ doped with a heteroatom may be in a range of about 0.1 to about 1.0 parts by weight based on 100 parts by weight of the total anode active material, and in some embodiments, in a range of about 0.2 to about 1.0 parts by weight based on 100 parts by weight of the total anode active material.

An average diameter of pores in the mesoporous TiO₂ doped with a heteroatom may be in a range of about 2 to about 15 nm, and in some embodiments, in a range of about 2 to about 10 nm, and in some embodiments, in a range of about 2 to about 8 nm.

A Brunauer-Emmett-Teller (BET) specific surface area of the mesoporous TiO₂ doped with a heteroatom may be in a range of about 100 to about 400 m²/g, and in some embodiments, in a range of about 100 to about 350 m²/g, and in some embodiments, in a range of about 100 to about 300 m²/g.

A pore volume of the mesoporous TiO₂ doped with a heteroatom may be in a range of about 0.1 to about 1.0 cc/g, and in some embodiments, in a range of about 0.2 to about 0.8 cc/g, and in some embodiments, in a range of about 0.2 to about 0.6 cc/g.

The mesoporous TiO₂ doped with a heteroatom may further include lithium titanate. The lithium titanate may include lithium titanate in a spinel phase, an anatase phase, or a ramsdellite phase.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic exploded perspective view of a lithium secondary battery according to an embodiment of the present invention;

FIGS. 2A to 2D are graphs illustrating an X-ray diffraction (XRD) spectrum of anode active materials for a lithium secondary battery prepared in Preparation Examples 1 to 4, respectively;

FIGS. 3A to 3D are graphs illustrating nitrogen adsorption curves of anode active materials for a lithium secondary battery prepared in Preparation Examples 1 to 4, respectively;

FIGS. 4A to 4D are graphs illustrating a pore size distribution of anode active materials calculated using a method of Barrett-Joyner-Halenda (BJH) for a lithium secondary battery prepared in Preparation Examples 1 to 4, respectively; and

FIGS. 5A to 5D are graphs illustrating an X-ray photoelectron spectroscopy (XPS) spectrum of anode active materials in a lithium secondary battery prepared in Preparation Examples 1 to 4, respectively.

### DETAILED DESCRIPTION

Hereinafter, reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not necessarily modify the individual elements of the list.

A lithium secondary battery according to one aspect of the present invention includes a cathode including a cathode active material; an anode including an anode active material; and electrolyte between the cathode and the anode. The anode active material includes mesoporous TiO₂ doped with a heteroatom. The term “mesoporous” used herein refers to pores that have an average pore diameter in a range of about 2 nm to about 50 nm.

Li₄Ti₅O₁₂ undergoes negligible expansion when lithium ions are charged and discharged, and thus Li₄Ti₅O₁₂, in comparison with graphite, shows excellent (e.g., improved) life-cycle characteristics. Also, as a result of the crystal structure of Li₄Ti₅O₁₂, mobility of lithium ions is excellent (e.g., improved), and thus high-rate discharge characteristics of Li₄Ti₅O₁₂ are superior to (e.g., improved compared to) other anode active materials.

However, Li₄Ti₅O₁₂, which is generally prepared by synthesizing TiO₂ nanoparticles and lithium carbonate (Li₂CO₃) by heat treatment at a high temperature, has a mass of TiO₂ nanoparticles, and has a capacity of only about 170 mAh/g.

Therefore, in order to manufacture a high-capacity battery, an anode active material having a higher capacity than the above-mentioned capacity is required.

The anode active material according to embodiments of the present invention includes mesoporous TiO₂ having a large specific surface area so that conductivity of Li⁺ ions is improved. Accordingly, a lithium secondary battery including the anode active material may have improved capacity.

In the mesoporous TiO₂ doped with a heteroatom, the heteroatom may include at least one atom selected from Group 15 or Group 16 elements.

In some embodiments, the mesoporous TiO₂ doped with a heteroatom may include a heteroatom that is at least one atom selected from nitrogen (N), sulfur (S), or phosphorous (P). For example, the heteroatom may include nitrogen (N).

An anode active material that is doped with the heteroatom for a lithium secondary battery may have increased capacity by having improved active material density.

The mesoporous TiO₂ doped with the heteroatom may be in an anatase phase (e.g., at least a portion of the mesoporous TiO₂ doped with the heteroatom may be in an anatase phase).

Depending on TiO₂ crystal structures, TiO₂ may be in one of the three phases classified by its crystallinity, namely, a orthorhombic brookite phase, a tetragonal anatase phase, or a rutile phase. Each phase is different in terms of its crystallinity and physiochemical properties depending on how the titanium ions and oxygen atoms are bound.

TiO₂ in a orthorhombic brookite phase has a semi-stable structure by titanium binding to oxygen atoms that have an asymmetric structure, and is stable at an intermediate temperature. Meanwhile, TiO₂ in a rutile and an anatase phases has a stable structure by titanium binding to oxygen atoms that have a symmetrical structure. The TiO₂ in the anatase phase is stable at a low temperature while TiO₂ in the rutile phase is stable at a high temperature.

The mesoporous TiO₂ doped with a heteroatom may be in the anatase phase, being stable at a low temperature, and the conductivity of Li⁺ ions may be improved.

A content of the mesoporous TiO₂ doped with a heteroatom may be in a range of about 0.1 parts to about 1.0 parts by weight based on 100 parts by weight of the anode active material. In some embodiments, the mesoporous TiO₂ doped with a heteroatom may be included in a range of about 0.2 parts to about 1.0 parts by weight based on 100 parts by weight of the anode active material.

In some embodiments, when the anode active material doped with a heteroatom is included within the above range, crystallinity is improved and band gap energy is reduced. Therefore, the conductivity of Li⁺ ions is improved, and accordingly capacity of a battery including the active material may be improved.

An average diameter of pores included in the mesoporous TiO₂ doped with a heteroatom may be in a range of about 2 nm to about 15 nm. In some embodiments, the average diameter of pores in the mesoporous TiO₂ doped with a heteroatom may be in a range of about 2 nm to about 10 nm, and in some embodiments, the average diameter of pores in the mesoporous TiO₂ doped with a heteroatom may be in a range of about 2 nm to about 8 nm.

In some embodiments, when the mesoporous TiO₂ doped with a heteroatom has an average pore diameter within the above range, capacity may be improved as a result of increasing its specific surface area.

A specific surface area of the mesoporous TiO₂ doped with a heteroatom (measured according to the Brunauer-Emmett-Teller (BET) method) may be in a range of about 100 m²/g to about 400 m²/g. In some embodiments the specific surface area (measured according to the Brunauer-Emmett-Teller (BET) method) of the mesoporous TiO₂ doped with a heteroatom may be in a range of about 100 m²/g to about 350 m²/g or about 100 to about 300 m²/g.

A pore volume of the mesoporous TiO₂ doped with a heteroatom may be in a range of about 0.1 cc/g to about 1.0 cc/g. In some embodiments, a pore volume of the mesoporous TiO₂ doped with a heteroatom may be in a range of about 0.2 cc/g to about 0.8 cc/g, or in other embodiments, a pore volume of the mesoporous TiO₂ doped with a heteroatom may be in a range of about 0.2 cc/g to about 0.6 cc/g.

The anode active material may further include lithium titanate.

Lithium titanate, depending on a crystal structure, may include spinel lithium titanate, anatase lithium titanate, and/or ramsdellite lithium titanate.

Lithium titanate may be represented by Li₄₋ₓTi₅O₁₂ (where 0≦x≦3). For example, the lithium titanate may be Li₄Ti₅O₁₂, but the lithium titanate may is not limited thereto.

A method of preparing an anode active material for the lithium secondary battery may include preparing TiO₂ doped with a heteroatom; adding a non-ionic surfactant to the TiO₂ doped with a heteroatom; and performing heat treatment at a temperature of about 400° C. to about 500° C. to remove the added non-ionic surfactant.

In order to prepare an anode active material for the lithium secondary battery, a titanium precursor and a non-metallic precursor are separately mixed with a solvent, and then are stirred together to prepare TiO₂ doped with a heteroatom.

That is, a titanium precursor is mixed with a solvent in a solution and the solution is mixed with a solution of a non-metallic precursor. Then, the mixture is stirred at a temperature of about 50° C. to about 150° C. for about 12 hours to about 50 hours to prepare TiO₂ doped with a heteroatom.

The titanium precursor may be at least one selected from TiCl₄, TiBr₄, Ti(OCH₃)₄, Ti(OC₂H₅)₄, Ti(OCH(CH₃)₂)₄, Ti(OC₄H₉)₄, or TiO(SO₄). In some embodiments, the titanium precursor may be TiCl₄ or TiBr₄.

The non-metallic precursor may be at least one selected from ammonia, (NH₄)₂SO₄, NH₄Cl, (NH₂)₂CO, (CH₃)₄NOH, or (C₂H₅)₃N. In some embodiments, the non-metallic precursor may be ammonia.

A solution of a titanium precursor and a solution of a non-metallic precursor are mixed to have a weight ratio of N:Ti in a range of about 3 to about 10. In some embodiments, when an anode active material has a N:Ti weight ratio within the above range, it has improved crystallinity and a reduced band gap energy to improve the conductivity of Li⁺ ions, and accordingly its capacity may be improved.

The solvent may be at least one selected from water, alcohol, or acetone. For example, the solvent may be water, isopropyl alcohol, ethanol, methoxy propanol, or butanol. In some embodiments, the solvent may be water, for example, distilled water. In addition, the solvent may assist in forming an anode active material in an anatase phase by enabling a rapid hydrolysis of the titanium precursor.

Next, a non-ionic surfactant is added to the TiO₂ doped with a heteroatom. Once the non-ionic surfactant is added, the nanocrystal TiO₂ doped with a heteroatom may form micelles around the non-ionic surfactant. Therefore, the non-ionic surfactant may function as a template.

The non-ionic surfactant may be a triblock copolymer.

The non-ionic surfactant also may include a hydrophilic block and a hydrophobic block.

Thus, the non-ionic surfactant including hydrophilic and hydrophobic blocks may control interactions between organic and inorganic materials, resulting in high workability as well as structural stability.

The non-ionic surfactant may be represented by, for example, Formula 1 or Formula 2.

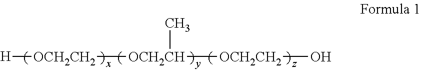

wherein x and z may be integers in a range of 10 to 200, y may be a integer in a range of 10 to 150, and a weight-average molecular weight may be in a range of about 1,000 g/mol to about 30,000 g/mol. For example, in Formula 1, x and z may be integers in a range of 10 to 150, y may be a integer in a range of 10 to 100, and a weight-average molecular weight may be in a range of about 3,000 g/mol to about 20,000 g/mol.

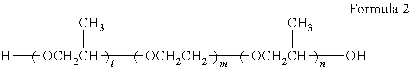

wherein l and n may be integers in a range of 10 to 200, m may be in a range 10 to 150, and a weight-average molecular weight may be in a range of about 1,000 g/mol to about 30,000 g/mol. For example, in Formula 2, l and n may be integers in a range of 10 to 150, m may in a range be 10 to 100, and a weight-average molecular weight may be in a range of about 3,000 g/mol to 20,000 g/mol.

The non-ionic surfactant may include, for example, Pluronic F68, Pluronic F127, or Pluronic P123 (Pluronic is a registered trademark of BASF Corporation, New Jersey).

The above-mentioned non-ionic surfactant may have relatively weak interactions between organic and inorganic materials, and its thermal stability may also be high.

The non-ionic surfactant may be added to the TiO₂ doped with a heteroatom at a ratio in a range of about 0.001 mol to about 0.1 mol based on 1 mol of Ti. For example, the non-ionic surfactant may be added to the TiO₂ doped with a heteroatom at a ratio in a range of about 0.01 mol to about 0.1 mol. Next, after cooling to room temperature, (CH₃)₄NOH is added thereto and stirred for about 1 to about 4 hours while adjusting the pH from 2 to 6. Then, the non-ionic surfactant included in the TiO₂ doped with a heteroatom is maintained at a temperature of 50° C. for about 48 hours.

In some embodiments, when the non-ionic surfactant is included in the TiO₂ doped with a heteroatom based on the molar ratio within the above range, a mesoporous structure is easily provided, an average pore diameter of the mesoporous TiO₂ doped with a heteroatom is in a range of about 2 nm to about 12 nm (for example, from about 3 nm to about 11 nm or from about 3 nm to about 10 nm).

Next, the non-ionic surfactant included in the TiO₂ doped with a heteroatom is dried at a temperature of 80° C. for about 24 hours, and heat treated at a temperature of 400° C. to 500° C. for about 4 to about 30 hours to remove the non-ionic surfactant.

In some embodiments, when the non-ionic surfactant is removed by performing the heat treatment at a temperature within the above range, an anode active material in the anatase phase lithium secondary battery is manufactured.

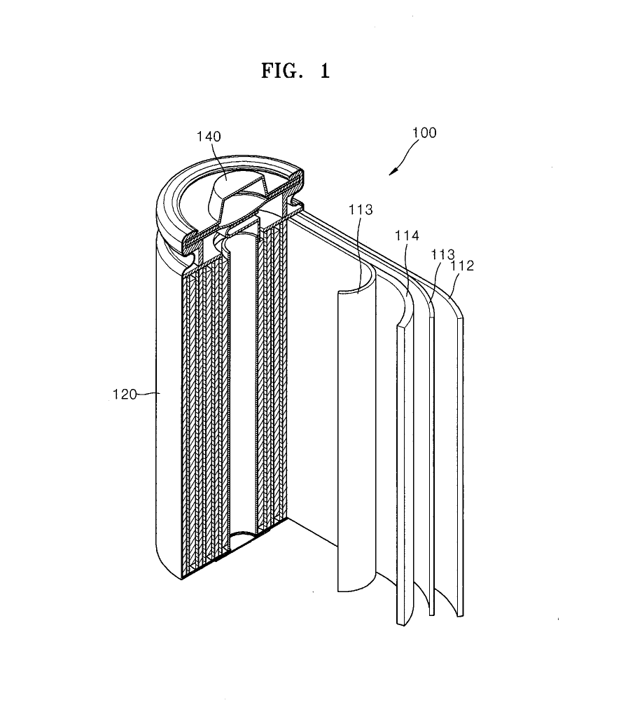

FIG. 1 is an exploded perspective view illustrating a lithium secondary battery 100 according to an embodiment of the present invention.

As shown in FIG. 1, the lithium secondary battery 100 includes a cathode 114, an anode 112, a separator 113 disposed between the cathode 114 and the anode 112. An electrolyte (not shown) is impregnated in the cathode 114, the anode 112, and the separator 113. The battery 100 also includes a battery case 120 and a sealing member 140 sealing the battery case 120. In the lithium secondary battery 100 shown in FIG. 1, the cathode 114, the separator 113, and the anode 112 are sequentially stacked, and then wound into a spiral form and inserted into the battery case 120.

The cathode 114 may include a current collector and a cathode active material thereon. As a cathode active material, a compound capable of reversible intercalation and deintercalation of lithium (i.e., a lithiated intercalation compound) may be used. Particular examples of the compound may be represented by any one of the following formulas:

LiₐA_{1-b}X_{b}D₂ (where 0.95≦a≦1.1 and 0≦b≦0.5); LiₐE_{1-b}X_{b}O_{2-c}D_{c} (where 0.95≦a≦1.1, 0≦b≦0.5, and 0≦c≦0.05; LiE_{2-b}X_{b}O_{4-c}D_{c} (where 0≦b≦0.5 and 0≦c≦0.05); LiₐNi_{1-b-c}Co_{b}BcD_{α} (where 0.95≦a≦1.1, 0≦b≦0.5, 0≦c≦0.05, and 0<α≦2); LiₐNi_{1-b-c}Co_{b}X_{c}O_{2-α}M_{α} (where 0.95≦a≦1.1, 0≦b≦0.5, 0≦c≦0.05, and 0<α<2); LiₐNi_{1-b-c}Co_{b}X_{c}O_{2-α}M₂ (where 0.95≦a≦1.1, 0≦b≦0.5, 0≦c≦0.05, and 0<α<2); LiₐNi_{1-b-c}Mn_{b}X_{c}D_{α} (where 0.95≦a≦1.1, 0≦b≦0.5, 0≦c≦0.05, and 0<α≦2); LiₐNi_{1-b-c}Mn_{b}X_{c}O_{2-α}M_{α} (where 0.95≦a≦1.1, 0≦b≦0.5, 0≦c≦0.05, and 0<α<2); LiₐNi_{1-b-c}Mn_{b}X_{c}O_{2-α}M₂ (where 0.95≦a≦1.1, 0≦b≦0.5, 0≦c≦0.05, and 0<α<2); LiₐNi_{b}E_{c}G_{d}O₂ (where 0.9≦a≦1.1, 0≦b≦0.9, 0≦c≦0.5, and 0.001≦d≦0.1); LiₐNi_{b}Co_{c}Mn_{d}GₑO₂ (where 0.9≦a≦1.1, 0≦b≦0.9, 0≦c≦0.5, 0≦d≦0.5, and 0≦e≦0.1); LiₐNiG_{b}O₂ (where, 0.9≦a≦1.1 and 0.001≦b≦0.1); LiₐCoG_{b}O₂ (where 0.9≦a≦1.1 and 0.001≦b≦0.1); LiₐMnG_{b}O₂ (where 0.9≦a≦1.1 and 0.001≦b≦0.1); LiₐMn₂G_{b}O₄ (where 0.9≦a≦1.1 and 0≦b≦0.1); QO₂; QS₂; LiQS₂; V₂O₅; LiV₂O₅; LiZO₂; LiNiVO₄; Li_{(3-f)}J₂(PO₄)₃ (where 0≦f≦2); Li_{(3-f)}Fe₂(PO₄)₃ (where 0≦f≦2); LiFePO₄; and lithium titanate.

In the formulas above, A may be selected from Ni, Co, Mn, or a combination thereof; X may be selected from Al, Ni, Co, Mn, Cr, Fe, Mg, Sr, V, a rare earth element, or a combination thereof; D may be selected from O, F, S, P, or a combination thereof; E may be selected from Co, Mn, or a combination thereof; M may be selected from F, S, P, or a combination thereof; G may be selected from Al, Cr, Mn, Fe, Mg, La, Ce, Sr, V, or a combination thereof; Q may be selected from Ti, Mo, Mn, or a combination thereof; Z may be selected from Cr, V, Fe, Sc, Y, or a combination thereof; and J may be selected from V, Cr, Mn, Co, Ni, Cu, or a combination thereof, but are not limited thereto.

Particular examples of the cathode active material may be LiₐNi_{b}Co_{c}Mn_{d}GₑO₂ (where 0.9≦a≦1.1, 0≦b≦0.9, 0≦c≦0.5, 0≦d≦0.5, and e=0, for example, a=1, b=0.5, c=0.2, d=0.3, and e=0) or LiMn₂O₄, but the cathode active material is not limited thereto.

In some embodiments, a lithium electrode may be used as the cathode 114.

A coating layer may be further formed on the surface of the compound that may be used as the cathode active material. The cathode active material may use a mixture of the above-mentioned compounds along with compounds including the coating layer. The coating layer may include at least one coating atom compound selected from oxides, hydroxides, oxyhydroxides, oxycarbonates, or hydroxycarbonates of the coating atoms. The compounds forming the coating layer may be amorphous or crystalline. Examples of the coating atoms included in the coating layer may be Mg, Al, Co, K, Na, Ca, Si, Ti, V, Sn, Ge, Ga, B, As, Zr, or a combination thereof.

A method of preparing the coating layer may include any suitable process, such as spray coating or dipping, as long as it does not adversely affect properties of the cathode active material. With regard to the method of preparing the coating layer, it may be known to those of ordinary skill in the art.

The cathode active material layer may also include a binder.

The binder strongly attaches particles of cathode active material to each other, and also strongly attaches the cathode active material to the current collector. Examples of the binder include polyvinylalcohol, carboxymethylcellulose, hydroxypropylcellulose, diacetylcellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, nylon, or the like, but the binder is not limited thereto.

An example of the current collector is Al, but it is not limited thereto.

The cathode 114 may be formed by mixing a cathode active material and a binder (and optionally a conductive material) in a solvent to form a composition for a cathode active material layer and spreading the composition on a current collector. Methods of manufacturing the cathode are known to those of ordinary skill in the art. An example of the solvent is N-methylpyrrolidone, but it is not limited thereto.

The cathode active material layer may further include a conductive material. The conductive material may be at least one selected from carbon, such as carbon black, Ketjen black, Denka black, acetylene black, artificial graphite, natural graphite; metal, such as copper powder, nickel powder, aluminum powder, silver powder; or polyphenylene, but the conductive material is not limited thereto.

The anode 112 may include an anode active material including the mesoporous TiO₂ doped with a heteroatom as described above. Depending on the desired performance of the lithium battery, the anode active material may be modified by mixing it with be at least one selected from natural graphite, a silicon/carbon complex (SiOₓ), silicon metal, a silicon thin film, lithium metal, a lithium alloy, a carbon material, or graphite.

In the composition of the anode active material layer, a binder and a solvent may be the same as those used in the cathode 114. A conductive material that may be optionally included in the composition for the anode active material layer may be the same as those used in the cathode 114. In some cases, a plasticizer may be further included in the composition of the cathode active material layer and/or of the anode active material layer to form pores in the cathode active material layer and/or anode active material layer.

The electrolyte may include a non-aqueous organic solvent and a lithium salt.

The non-aqueous organic solvent functions as a medium for transferring ions that are involved in an electrochemical reaction of the battery.

Examples of the non-aqueous organic solvent include a carbonate-based, ester-based, ether-based, ketone-based, alcohol-based, and/or aprotic-based solvent. The carbonate-based solvent may be dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), ethylmethyl carbonate (EMC), or the like. The ester-based solvent may be methyl acetate, ethyl acetate, n-propyl acetate, dimethyl acetate, methyl propionate, ethyl propionate, γ-butyrolactone, decanolide, valerolactone, mevalonolactone, caprolactone, or the like. The ether-based solvent may be dibutyl ether, tetraglyme, diglyme, dimethoxyethane, 2-methyl-tetrahydrofuran, or the like. The ketone-based solvent may be cyclohexanone or the like. The alcohol-based solvent may be ethyl alcohol, isopropyl alcohol, or the like. The aprotic-based solvent may be a nitrile, such as R—CN (where R includes a linear, branched, or ring structure and is C2 to C20, and optionally includes a ring having a double bond or an ether bond), an amide, such as dimethylformamide, or dioxolane sulfolane, such as 1,3-dioxolane.

The non-aqueous organic solvent may be used alone or a mixture of solvents may be used. When a mixture is used, the mixture ratio may be adjusted depending on the desired battery properties, which is known to those of ordinary skill in the art.

The lithium salt is dissolved in the organic solvent and acts as a source of lithium ions within the battery, and also allows movement of lithium ions between the cathode and the anode. The lithium salt may include at least one supporting electrolytic salt selected from LiPF₆, LiBF₄, LiSbF₆, LiAsF₆, LiN(SO₂C₂F₅)₂, Li(CF₃SO₂)₂N, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, LiI, and/or LiB(C₂O₄)₂ (lithium bis(oxalato) borate; LiBOB). A concentration of the lithium salt may be in a range of about 0.1 to about 2.0 M. In some embodiments, when the concentration of the lithium salt is within the above range, the electrolyte has proper conductivity and viscosity, and thus exhibits excellent (e.g., improved) electrolyte performance for effective movement of the lithium ions.

Depending on the type of lithium secondary battery 100, a separator 113 may be disposed between a cathode 114 and an anode 112. The separator 113 may be polyethylene, polypropylene, polyvinylidene fluoride, or a multilayer including a combination thereof. Here, a mixed multilayer film may be used as well, such as a 2-layer separator of polyethylene/polypropylene, a 3-layer separator of polyethylene/polypropylene/polyethylene, or a 3-layer separator of polypropylene/polyethylene/polypropylene.

Depending on the type of separator and electrolyte used, the lithium secondary battery may be classified as a lithium ion battery, a lithium ion polymer battery, or a lithium polymer battery. In addition, the lithium secondary battery may be classified as a coin-type battery or a pouch-type battery depending on the type of formation. Also, the lithium secondary battery may be classified as a bulk-type battery or a thin film-type battery depending on its size. A method of manufacturing such batteries is known to those of ordinary skill in the art.

Hereinafter, one or more embodiments of the present invention concept will now be described in detail with reference to the following examples. However, these examples are not intended to limit the scope of the one or more embodiments of the present invention.

(Manufacture of an anode active material for a lithium secondary battery)

### Preparation Example 1

An aqueous ammonia solution was added to an aqueous TiCl₄ solution at a N:Ti weight ratio of 5:1 and then the mixture was stirred to prepare TiO₂ doped with N atoms. Pluronic P123 (from BASF Corp.), a non-ionic surfactant, was added to the TiO₂ doped with N atoms at a ratio of about 0.1 mol based on 1 mol of Ti, and then stirred at a temperature of 50° C. for about 48 hours. Thereby, micelles including the TiO₂ doped with N atoms formed around the non-ionic surfactant are formed. Next, the micelles were dried at a temperature of 80° C. for about 24 hours, and then calcined at a temperature of 400° C. for about 24 hours to remove the non-ionic surfactant and to prepare an anode active material for a lithium secondary battery of mesoporous TiO₂ doped with N atoms having an average pore size of 8.1 nm, a BET specific surface area of 185 m²/g, and a pore volume of 0.408 cc/g.

### Preparation Example 2

An anode active material for a lithium secondary battery of mesoporous TiO₂ doped with N atoms was prepared in the same manner as in Example 1, except that Pluronic P123 (from BASF Corp.), a non-ionic surfactant, was added to the TiO₂ doped with N atoms at a ratio of about 0.8 mol based on 1 mol of Ti to prepare an anode active material for a lithium secondary battery of mesoporous TiO₂ doped with N atoms having an average pore size of 6.2 nm, a BET specific surface area of 180 m²/g, and a pore volume of 0.347 cc/g.

### Preparation Example 3

An aqueous ammonia solution was added to an aqueous TiCl₄ solution at a N:Ti weight ratio of 7:1, and then the mixture was stirred to prepare TiO₂ doped with N atoms. An anode active material for a lithium secondary battery of mesoporous TiO₂ doped with N atoms was prepared in the same manner as in Example 1, except that Pluronic P123 (from BASF Corp.), a non-ionic surfactant, was added to the TiO₂ doped with N atoms at a ratio of about 0.06 mol based on 1 mol of Ti to prepare an anode active material for a lithium secondary battery of mesoporous TiO₂ doped with N atoms having an average pore size of 5.3 nm, a BET specific surface area of 218 m²/g, and a pore volume of 0.359 cc/g.

### Preparation Example 4

An aqueous ammonia solution was added to an aqueous TiCl₄ solution at a N:Ti weight ratio of 9:1 and then the mixture was stirred to prepare TiO₂ doped with N atoms. An anode active material for a lithium secondary battery of mesoporous TiO₂ doped with N atoms was prepared in the same manner as in Example 1, except that a Pluronic P123 (from BASF Corp.) non-ionic surfactant was added to the TiO₂ doped with N atoms at a ratio of about 0.04 mol based on 1 mol of Ti to prepare an anode active material for a lithium secondary battery of mesoporous TiO₂ doped with N atoms having an average pore size of 5.1 nm, a BET specific area of 212 m²/g, and a pore volume of 0.324 cc/g.

### Comparative Preparation Example 1

An aqueous (NH₄)₂SO₄ solution was added to an TiCl₄ solution at a TiCl₄:(NH₄)₂SO₄:H₂O molar ratio of 1:0.08:73.2 and then the mixture was stirred at a temperature of 90° C. for about 24 hours followed by being cooled down to a temperature of 25° C. to obtain a mixture of TiCl₄, (NH₄)₂SO₄, and H₂O. Next, the mixture was dried at a temperature of 80° C. for about 12 hours and then calcined at a temperature of 400° C. for about 3 hours to prepare an anode active material for a lithium secondary battery of TiO₂.

### Comparative Example 2

Li₄Ti₅O₁₂ (from PuriChem Specialty Chemicals, Pennsylvania) was prepared as an anode active material for a lithium secondary battery.

(Manufacture of a lithium secondary battery)

### Example 1

A slurry was prepared by mixing an anode active material for a lithium secondary battery of Preparation Example 1, polyvinylidene fluoride as a binder, and Denka black as a conductive material at a ratio of 90:5:5 in N-Methyl-pyrrolidone (NMP), as a solvent.

The slurry was coated on an aluminum foil with a thickness of 15 μm to prepare an anode by vacuum drying it at a temperature of 60° C. for about 12 hours.

Next, the anode was wound to have a circular shape with a diameter of 10 φ. A coin cell of CR-2032 was prepared by forming an opposite electrode of a lithium metal, forming a separator of polypropylene and using a solution in which 1.0M of LiPF₆ was dissolved in ethylene carbonate (EC) and ethyl methyl carbonate (EMC), which were mixed in a volume ratio of 3:7, as an electrolyte solution.

### Example 2

A CR-2032 standard coin cell was prepared in the same manner as Example 1 except that an anode active material for a lithium secondary battery of Preparation Example 2 was used instead of the anode active material for the lithium secondary battery of Preparation Example 1.

### Example 3

A CR-2032 standard coin cell was prepared in the same manner as Example 1 except that an anode active material for a lithium secondary battery of Preparation Example 3 was used instead of the anode active material for the lithium secondary battery of Preparation Example 1.

### Example 4

A CR-2032 standard coin cell was prepared in the same manner as Example 1 except that an anode active material for a lithium secondary battery of Preparation Example 4 was used instead of the anode active material for the lithium secondary battery of Preparation Example 1.

### Comparative Example 1

A CR-2032 standard coin cell was prepared in the same manner as Example 1 except that an anode active material for a lithium secondary battery of Comparative Preparation Example 1 was used instead of the anode active material for the lithium secondary battery of Preparation Example 1.

### Comparative Example 2

A CR-2032 standard coin cell was prepared in the same manner as Example 1 except that an anode active material for a lithium secondary battery of Comparative Preparation Example 2 was used instead of the anode active material for the lithium secondary battery of Preparation Example 1.

### EVALUATION EXAMPLE

### Evaluation Example 1

### Evaluation of Crystallinity (XRD Test)

An X-ray diffraction (XRD) test was performed on anode active materials of lithium secondary batteries prepared according to Preparation Examples 1 to 4 by using an X′Pert PRO MRD diffractometer manufactured by PANalytical, Netherlands, using a Cu—Kα X-ray at a wavelength of 1.541 Å, a tube current of 25 mA, and a voltage of 40 kV.

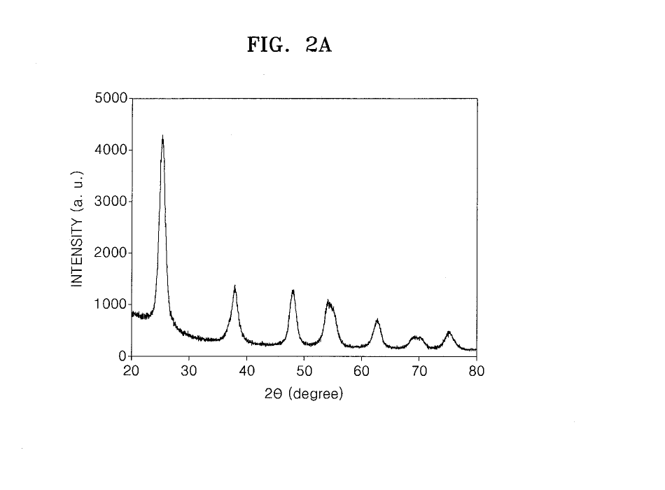

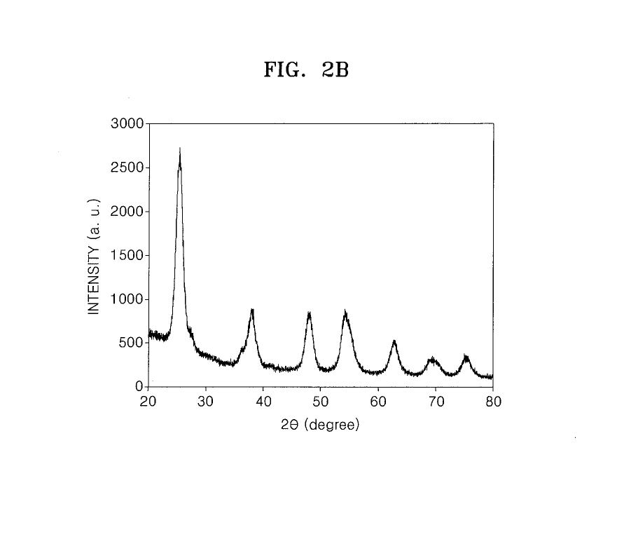

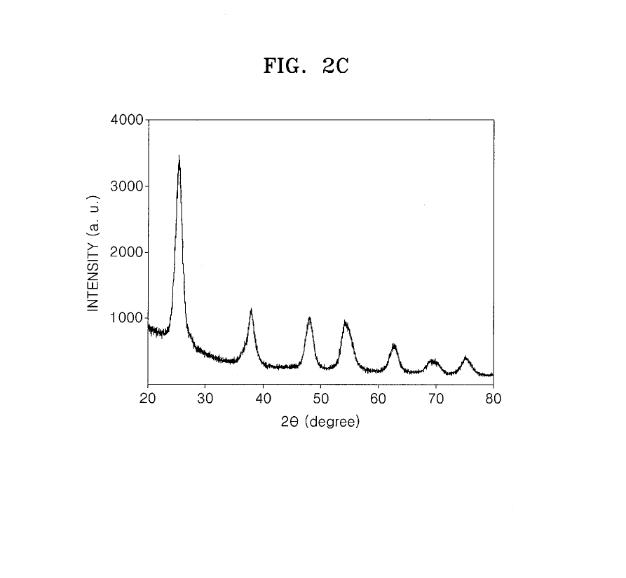

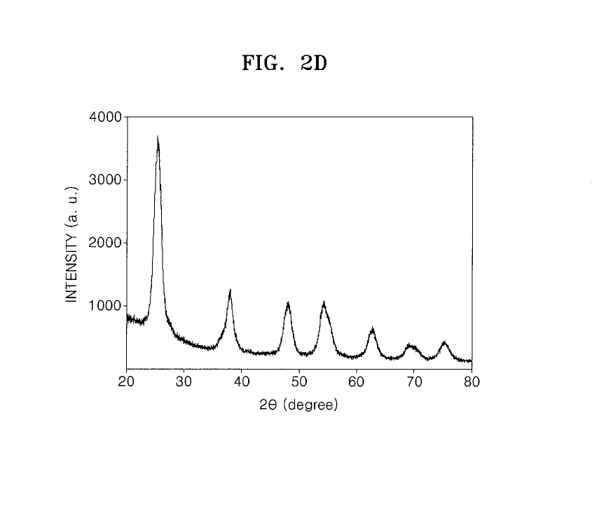

Results are shown in Table 1 below and FIGS. 2A to 2D.

TABLE 1

| | | Size of crystalline |
|---|---|---|
| | Crystallinity | particles (nm) |
| Preparation | Anatase phase | 7.5 |
| Example 1 | | |
| Preparation | Anatase phase | 7.0 |
| Example 2 | | |
| Preparation | Anatase phase | 6.6 |
| Example 3 | | |
| Preparation | Anatase phase | 6.5 |
| Example 4 | | |

Referring to FIGS. 2A to 2D, it was confirmed that the anode active materials for the lithium secondary batteries prepared according to Preparation Examples 1 to 4 have an anatase phase structure due to diffraction peaks 101, 004, and 200. The diffraction peaks 101, 004, and 200 were observed at a Bragg 2θ of 25°, 38°, and 48°, respectively.

Also, the size of crystalline particles of the anode active materials for the lithium secondary batteries prepared according to Preparation Examples 1 to 4 was calculated using Scherrer's formula from the main diffraction peak 101. As a result, it was confirmed that the size of the crystalline particles of the anode active materials for the lithium secondary batteries prepared according to Preparation Examples 1 to 4 was in a range of about 6.5 nm to about 7.5 nm.

### Evaluation Example 2

### Evaluation of Pore Characteristics (Nitrogen Absorption Curve)

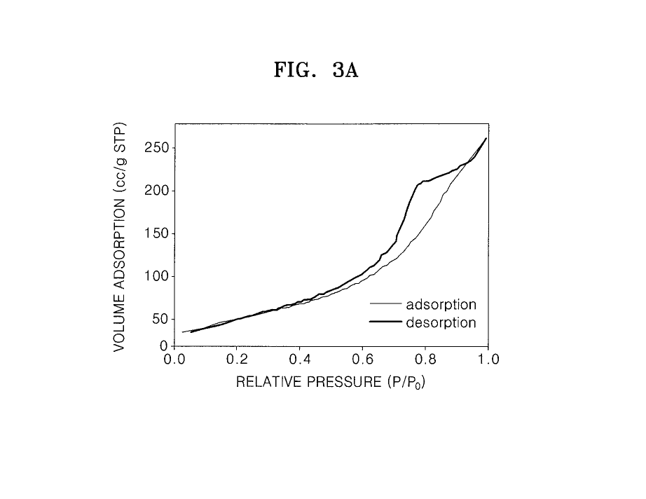

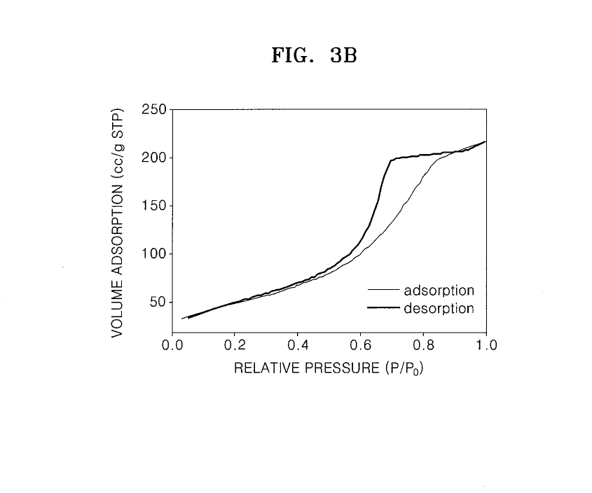

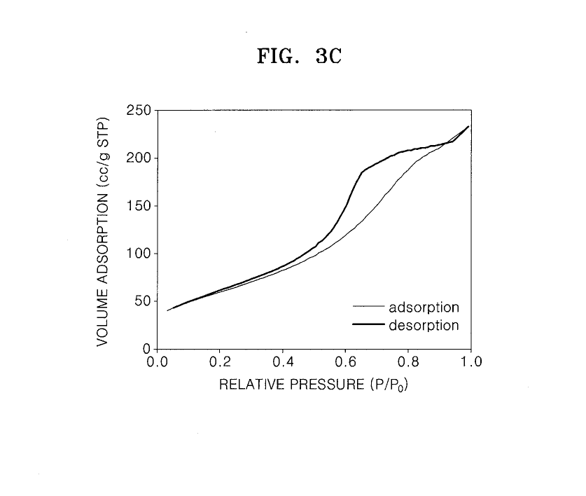

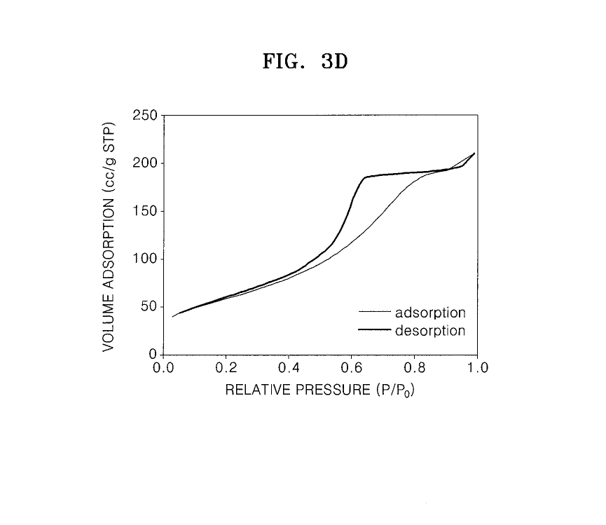

Average pore diameter and pore volume of the anode active materials for the lithium secondary batteries prepared according to Preparation Examples 1 to 4, which were treated by vacuum degassing at a temperature of 200° C. for about 120 minutes, were measured using a nitrogen adsorption and desorption apparatus (i.e., a QUADRASORB SI adsorption apparatus manufactured by Quantachrome Instruments, Florida). Results are shown in Table 2 below and FIGS. 3A to 3D.

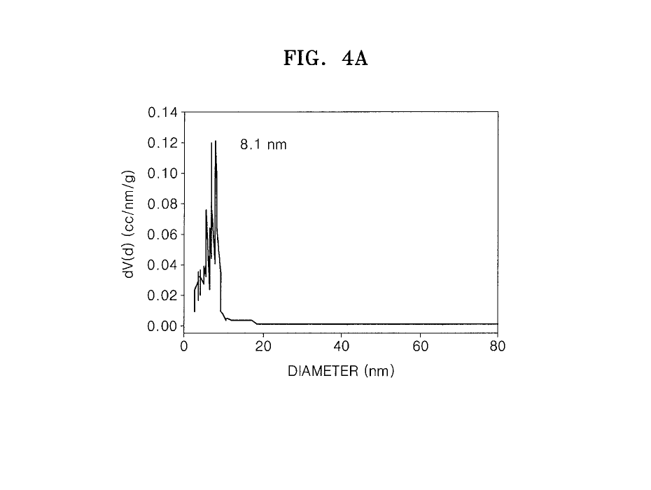

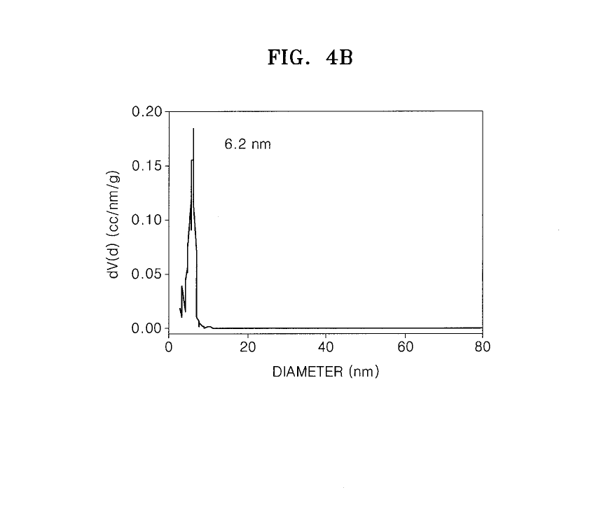

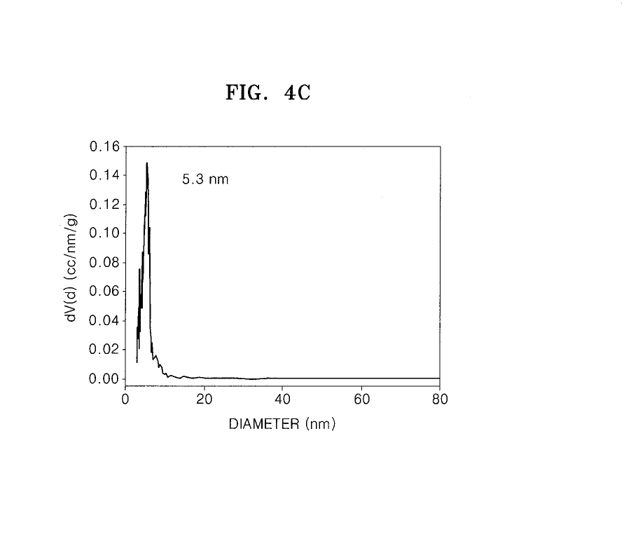

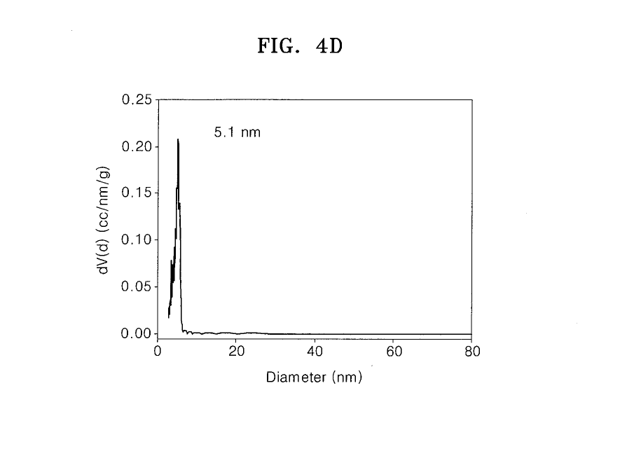

Also, an average pore diameter may be confirmed by FIGS. 4A to 4D illustrating a pore size distribution calculated using the Barrett-Joyner-Halenda (BJH) method. The BET specific surface area was calculated by using a BET method within a relative range of nitrogen pressure (P/P₀) that is between about 0 to about 1.0 (P/P₀).

TABLE 2

| | Average pore | BET specific | |
|---|---|---|---|
| | diameter | surface area | Pore volume |
| | (nm) | (m²/g) | (cc/g) |
| Preparation | 8.1 | 185 | 0.408 |
| Example 1 | | | |
| Preparation | 6.2 | 180 | 0.347 |
| Example 2 | | | |
| Preparation | 5.3 | 218 | 0.359 |
| Example 3 | | | |
| Preparation | 5.1 | 212 | 0.324 |
| Example 4 | | | |

Referring to Table 2, FIGS. 3A to 3D, and FIGS. 4A to 4D, it was confirmed that the anode active materials for the lithium secondary batteries prepared according to Preparation Examples 1 to 4 have an average pore diameter in a range of about 5.1 nm to about 8.1 nm, a BET specific surface area in a range of about 180 m²/g to about 218 m²/g, and a pore volume in a range of about 0.324 cc/g to about 0.408 cc/g.

### Evaluation Example 3

### Evaluation of Amounts of Materials Doped with a Heteroatom (XPS Analysis)

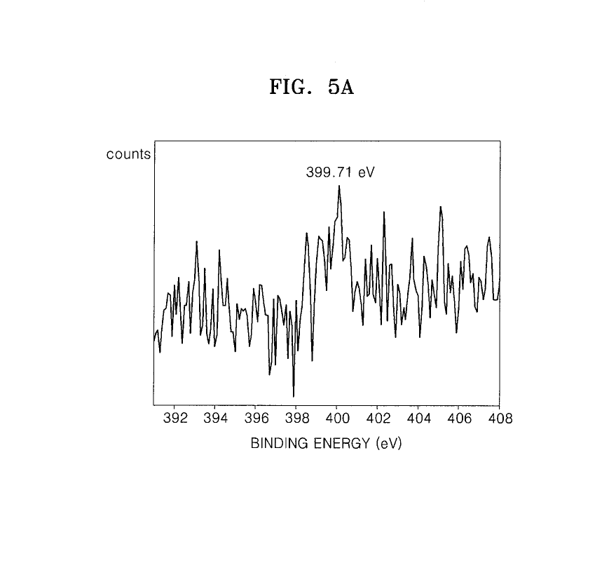

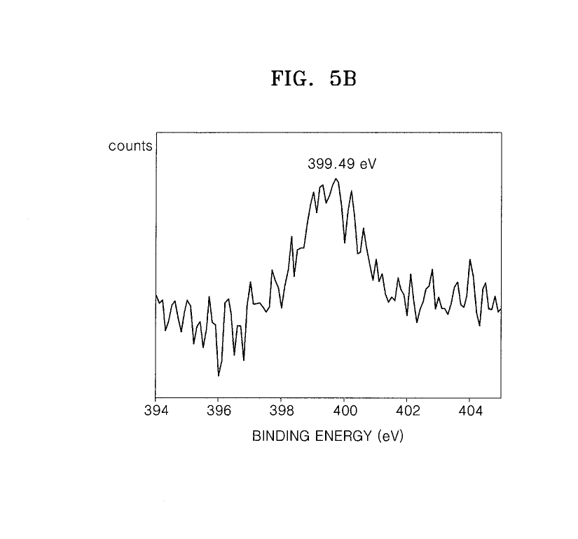

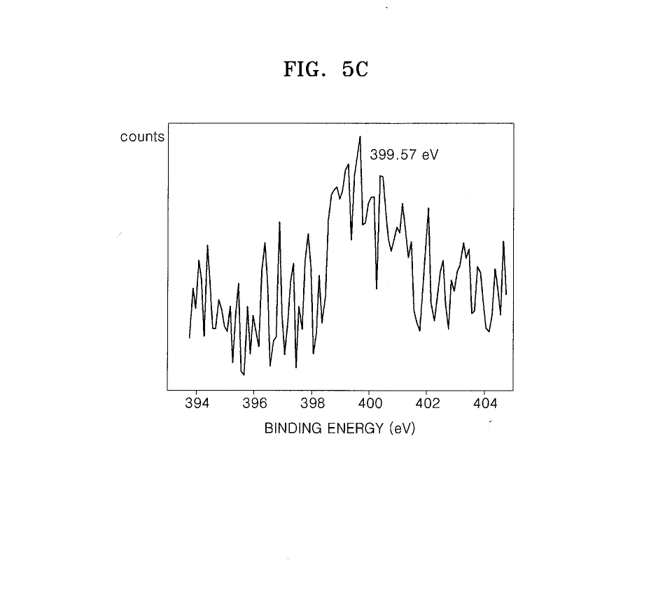

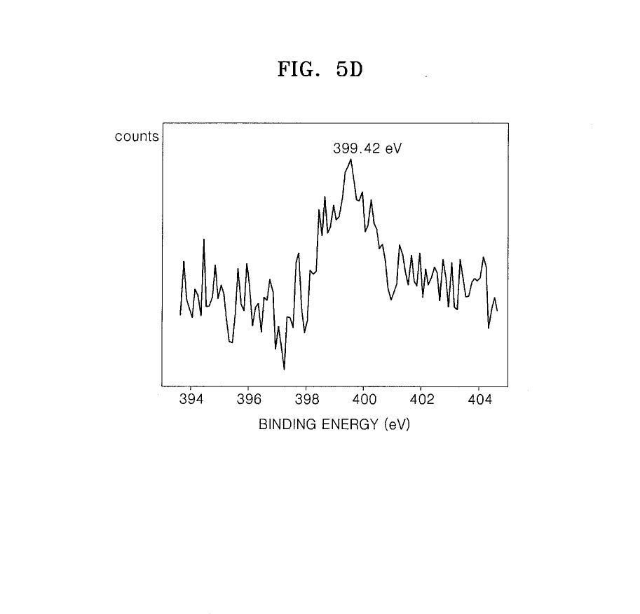

X-ray photoelectron spectroscopy (XPS) analysis was performed on anode active materials of lithium secondary batteries prepared according to Preparation Examples 1 to 4 by using a Multilab-2000 (manufactured by Fisher Scientific Company, Massachusetts) to calculate the spectrum within an inner level of the N1s orbital. Accordingly, the area of the peak position was divided by an atomic sensitivity factor based on 100 parts by weight of the total anode active material to analyze amounts of materials doped with a heteroatom, wherein a binding energy of about 399.5 eV is energy from the anode active materials for the lithium secondary batteries prepared according to Preparation Examples 1 to 4. The results are shown in Table 3 below and FIGS. 5A to 5D.

TABLE 3

| | Amount of material doped with N atoms based on 100 |
|---|---|
| | parts by weight of the total anode active material |
| Preparation | 0.36 |
| Example 1 | |
| Preparation | 0.77 |
| Example 2 | |
| Preparation | 0.17 |
| Example 3 | |
| Preparation | 0.37 |
| Example 4 | |

Referring to Table 3 and FIGS. 5A to 5D, it was confirmed that the anode active materials for the lithium secondary batteries prepared according to Preparation Examples 1 to 4 had a peak corresponding to a binding energy of about 399.5 eV of a N1s orbital. A peak corresponding to the binding energy of about 399.5 eV was the peak formed by Ti—O—N bond, and thus it was confirmed that the anode active materials for the lithium secondary batteries prepared according to Preparation Examples 1 to 4 were doped with N atoms. By XPS analysis, it was confirmed that the amount of materials doped with N atoms were in a range of about 0.17 to about 0.77 parts by weight based on 100 parts by weight of the total anode active material.

### Evaluation Example 4

### Evaluation of Capacity

The CR-2032 standard coin cells prepared according to Example 1 and Comparative Examples 1 and 2 were charged with a constant current at a 0.2 C rate and with a constant voltage of 1 V to a 0.01 C cut-off rate and were rested for about 10 minutes. Then, the coin cells were discharged with a constant current at a 0.5 C, 1 C, 2 C, and 5 C rate until their respective voltages reached 3.0 V. That is, by changing the charge and discharge rates to a 0.2 C, 0.5 C, 1 C, 2 C, and 5 C rate, respectively, the charge capacity and discharge capacity of each of the coin cells were evaluated. Results were shown in Tables 4 to 6 below.

In Tables 4 to 6 below, a ‘C-rate’ represents the discharge rate of the coin cells, which was obtained by dividing the total capacity of the coin cells by the total discharge time. Table 4 below shows the results of characteristics of the lithium secondary battery according to Example 1, and Tables 5 and 6 show the results of characteristics of the lithium secondary battery according to Comparative Examples 1 and 2, respectively.

TABLE 4

| | Charge | Discharge |
|---|---|---|
| | capacity (mAh/g) | capacity (mAh/g) |
| Formation | 221 | 253 |
| 0.5 C | 215 | 234 |
| 1 C | 210 | 226 |
| 2 C | 202 | 219 |
| 5 C | 190 | 214 |

TABLE 5

| | Charge | Discharge |
|---|---|---|
| | capacity (mAh/g) | capacity (mAh/g) |
| Formation | 170 | 210 |
| 0.5 C | 144 | 193 |
| 1 C | 130 | 171 |
| 2 C | 123 | 165 |
| 5 C | 116 | 160 |

TABLE 6

| | Charge | Discharge |
|---|---|---|
| | capacity (mAh/g) | capacity (mAh/g) |
| Formation | 168 | 170 |
| 0.5 C | 166 | 169 |
| 1 C | 165 | 169 |
| 2 C | 163 | 168 |
| 5 C | 161 | 168 |

Referring to Tables 4 to 6, it was confirmed that the lithium secondary battery according to Example 1 shows more improved charge capacity than the lithium secondary batteries according to Comparative Examples 1 and 2. Therefore, it may be confirmed that the capacity of the lithium secondary battery according to Example 1 is more improved compared to the lithium secondary batteries according to Comparative Examples 1 and 2.

According to an aspect of the present invention, an anode active material for a lithium secondary battery has a mesoporous structure with a large specific surface area so that a lithium secondary battery including the same may have improved conductivity of lithium ions and accordingly have improved capacity.

While the present invention has been particularly shown and described with reference to exemplary embodiments thereof, it will be understood by those of ordinary skill in the art that various changes in form and details may be made therein without departing from the spirit and scope of the present invention as defined by the following claims and equivalents thereof.

What is claimed is:

1. A lithium secondary battery comprising:
a cathode comprising a cathode active material;
an anode comprising an anode active material comprising mesoporous TiO₂ doped with a heteroatom; and
an electrolyte.

2. The lithium secondary battery of claim 1, wherein the mesoporous TiO₂ doped with a heteroatom comprises at least one atom selected from the group consisting of a Group 15 element and a Group 16 element.

3. The lithium secondary battery of claim 1, wherein the mesoporous TiO₂ doped with a heteroatom comprises at least one atom selected from the group consisting of nitrogen (N), sulfur (S), and phosphorous (P).

4. The lithium secondary battery of claim 1, wherein the mesoporous TiO₂ doped with a heteroatom is in an anatase phase.

5. The lithium secondary battery of claim 1, wherein an amount of the mesoporous TiO₂ doped with a heteroatom is in a range of about 0.1 to about 1.0 parts by weight based on 100 parts by weight of the total anode active material.

6. The lithium secondary battery of claim 1, wherein an average diameter of pores in the mesoporous TiO₂ doped with a heteroatom is in a range of about 2 to about 15 nm.

7. The lithium secondary battery of claim 1, wherein an average diameter of pores in the mesoporous TiO₂ doped with a heteroatom is in a range of about 2 to about 10 nm.

8. The lithium secondary battery of claim 1, wherein a Brunauer-Emmett-Teller (BET) specific surface area of the mesoporous TiO₂ doped with a heteroatom is in a range of about 100 to about 400 m²/g.

9. The lithium secondary battery of claim 1, wherein a Brunauer-Emmett-Teller (BET) specific surface area of the mesoporous TiO₂ doped with a heteroatom is in a range of about 100 to about 350 m²/g.

10. The lithium secondary battery of claim 1, wherein a Brunauer-Emmett-Teller (BET) specific surface area of the mesoporous TiO₂ doped with a heteroatom is in a range of about 100 to about 300 m²/g.

11. The lithium secondary battery of claim 1, wherein a pore volume of the mesoporous TiO₂ doped with a heteroatom is in a range of about 0.1 to about 1.0 cc/g.

12. The lithium secondary battery of claim 1, wherein a pore volume of the mesoporous TiO₂ doped with a heteroatom is in a range of about 0.2 to about 0.8 cc/g.

13. The lithium secondary battery of claim 1, wherein a pore volume of the mesoporous TiO₂ doped with a heteroatom is in a range of about 0.2 to about 0.6 cc/g.

14. The lithium secondary battery of claim 1, wherein the anode active material further comprises lithium titanate.

15. The lithium secondary battery of claim 14, wherein the lithium titanate comprises lithium titanate in a spinel phase, an anatase phase, or a ramsdellite phase.
